(19) United States
(12) Patent Application Publication
(10) Pub. No.: US 2005/0033203 A1
(43) Pub. Date: Feb. 10, 2005

(54) Device for promoting decomposition of body fat and enhancing muscular strength

(76) Inventor: Ho-Sang Son, Yongin City (KR)

Correspondence Address: LADAS & PARRY LLP, 224 SOUTH MICHIGAN AVENUE, SUITE 1200, CHICAGO, IL, 60604, US

(21) Appl. No.: 10/501,244

(22) PCT Filed: Jan. 11, 2003
(86) PCT No.: PCT/KR03/00059

(30) Foreign Application Priority Data
Jan. 11, 2002 (KR) 10-2002-0001611
Jan. 11, 2003 (KR) 10-2003-0001799

(51) Int. Cl. A61H 7/00

(52) U.S. Cl. 601/98; 601/97

(57) ABSTRACT

Disclosed is a device for promoting decomposition of body fat and enhancing muscular strength, comprising: a base seated on a horizontal surface; a post uprightly provided in the front part of the base; a foothold mounted to be vertically movable on the base; a drive unit provided in the base to periodically and alternately raise and lower the opposite ends of the foothold; and a control section provided on the post for controlling the drive of the drive unit. The drive unit comprises a drive source mounted on the base, rotational shafts, which are respectively connected to driving axes extending from the opposite sides of the drive source, balance weights each being secured to one of the rotational shafts, which extend through the balance weights, eccentric axles each being directly formed on one of the rotational shafts, and connecting rods each being connected to one of the eccentric axles.

### TECHNICAL FIELD

The present invention relates to a device for promoting decomposition of body fat and enhancing muscular strength, and more particularly to a device for promoting decomposition of body fat and enhancing strength, which converts rotational energy into vibrational energy in order to provide well-defined stimulation to a user, thereby maximizing the effect of treatment of obesity for the user.

### BACKGROUND ART

Exercise devices, which have been used for promoting decomposition of body fat and enhancing muscular strength or for treating obesity, have performed a function for exercising a limited part of a user's body. When using such exercise devices, a certain extent of desired effect can be obtained only when exercises are taken for a predetermined length of time every day over a long period.

Exercise devices, which are constructed to provide exercise effect a user while being operated with spontaneous muscular activity of the user, may be set to a weight exceeding the muscular strength of the user. In such a case, in order to take proper exercise with suitable difficulty, the user typically reduces the load needed to operate the exercise devices, i.e., the weight.

In addition, because existing exercise devices do not have a capability to provide an exercise effect without spontaneous movement by the user, a coercive measure should be taken in order to oxidize body fat. For this reason, unless a user takes exercise every day or at least periodically for a predetermined length of time, the user is liable to suffer from the so-called “yo-yo phenomenon in weight loss.

Furthermore, existing exercise devices are typically constructed to help treatment of obesity or enhancement of muscular strength for a limited part of body. Therefore, there is an inconvenience in that various types of exercise devices should be stocked in order to treat obesity or decompose body fat for all the various parts of body.

In order to achieve the expected results, it is essential to take exercise for a predetermined length of time every day over a long period. As a result, most users neglect exercise due to busy daily schedules and eventually give up exercise halfway through a regimen.

In using an exercise device, a certain level of a user's muscular strength is needed. A physically handicapped person is restricted in using such an exercise device. For example, a patient who suffers from serious obesity in the lower part of the body may be injured by the body being overstrained due to the troubles in knee joints and ankle joints or may have a difficulty in taking exercise without others' assistance.

### DISCLOSURE OF THE INVENTION

Therefore, the present invention has been made in view of the above-mentioned problems, and it is an object of the present invention to provide a device for promoting decomposition of body fat and enhancing muscular strength, which is capable of affording exercise effects for the many various parts of the body, is effective in treating obesity only through exercise over a short period of time, and allows a user to efficiently achieve exercise effects by the automatically-exerted power of the exercise device without needing the spontaneous muscular movements of the user.

It is another object of the present invention to provide a device for promoting decomposition of body fat and enhancing muscular strength, which allows a physically handicapped user to efficiently achieve the effect of treating obesity, i.e., decomposition of body fat.

It is still another object of the present invention to provide a device for promoting decomposition of body fat and enhancing muscular strength, which allows an user to efficiently achieve exercise effects by automatically-exerted power of the exercise device and induces spontaneous decomposition of body fat and enhancement of muscular strength, thereby contributing to controlling a “yo-yo” phenomenon.

In order to accomplish these objects, according to one aspect of the present invention, there is provided a device for promoting decomposition of body fat and enhancing muscular strength, comprising: a base seated on a horizontal surface; a post uprightly provided in the front part of the base; a foothold mounted to be vertically movable on the base, on which a user rests his feet; a drive unit provided in the base in order to periodically and alternately raise and lower the opposite ends of the foothold; and a control section provided on the post for controlling the drive of the drive unit, wherein the drive unit comprises a drive source mounted on the base, rotational shafts, which are respectively connected to driving axes extending from the opposite sides of the drive source, balance weights each being secured to one of the rotational shafts, which extend through the balance weights, eccentric axles each being directly formed on one of the rotational shafts, and connecting rods each being connected to one of the eccentric axles.

Here, the foothold is abutted at the center part between the left and right ends thereof, and the connecting rods are connected to fastening means secured to each end of the foothold, so that the connecting rods afford periodic seesaw movements to the foothold.

Preferably, the eccentric axles formed on the rotational shafts and connected to the connecting rods have a phase difference of 180° between them, so that if one of the eccentric axles is positioned at the uppermost position, the other is positioned at the lowermost position while the rotational shafts are rotating.

In addition, the rotational diameter of the connecting rods connected to the eccentric axles of the rotational shafts is in the range of 1 to 14 mm, and the rotational speed of the connecting rods is in the range of 1 to 60 cycles/sec.

Furthermore, the control panel controls the vibrational speed in the range of 30 to 60 Hz at high-speed vibrational exercise mode, and controls the vibrational speed in the range of 1 to 29 Hz at low-speed vibrational excise mode.

According to another aspect of the present invention, there is provided a device for promoting decomposition of body fat and enhancing muscular strength, comprising: a base seated on a horizontal surface; a post uprightly provided in the front part of the base; a foothold mounted to be vertically movable on the base, on which a user rests his feet; a drive unit provided in the base in order to periodically and alternately raise and lower the opposite ends of the foothold; and a control section provided on the post for controlling the drive of the drive unit, wherein the drive unit comprises a drive source mounted on the base, couplings connected to driving axes extending from the opposite sides of the drive source, joint members residing between the couplings in order to reduce noise and friction, rotational shafts connected to the joint members, balance weights each secured to one of the rotational shafts which extend through the balance weights, eccentric axles each being directly formed on one of the rotational shafts, and connecting rods each being directly connected to one of the eccentric axles.

Here, each coupling is formed from two toothed gears, which are mated with each other thereby transferring rotational movements.

According to another aspect of the present invention, there is provided a device for promoting decomposition of body fat and enhancing muscular strength, comprising: a base seated on a horizontal surface; a post uprightly provided in the front part of the base; a foothold mounted to be vertically movable on the base, on which a user rests his feet; a drive unit provided in the base in order to periodically and alternately raise and lower the opposite ends of the foothold, and a control section provided on the post for controlling the drive of the drive unit, wherein the drive unit comprises a drive source mounted on the base, rotational shafts connected to driving axes extending from the opposite sides of the drive source, eccentric cams each eccentrically secured to one of the rotational shafts, bearings each fitted around one of the eccentric cams, housings each fitted to enclose one of the eccentric cams, foothold connection parts connected to the foothold, length-controlled tie rods each extending between one of the housings and one of the foothold connection parts and screwed to the housing and the foothold connection part at its opposite ends, and anchoring nuts for securing the adjusted lengths of the tie rods connected to the housings and foothold connection parts.

Here, the foothold is abutted at the center part between the left and right ends thereof, and the connecting rods are connected to fastening means secured to each end of the foothold, so that the connecting rods afford periodic seesaw movements to the foothold.

The fastening means comprises connecting means and left and right brackets.

In addition, one of the left and right brackets is provided with securing holes extending in a predetermined length so that the connecting means is movable in the widthwise direction of the bracket.

According to still another aspect of the present invention, there is provided a device for promoting decomposition of body fat and enhancing muscular strength, comprising: a base seated on a horizontal surface; a post uprightly provided in the front part of the base; a foothold mounted to be vertically movable on the base, on which a user rests his feet; a drive unit provided in the base in order to periodically and alternately raise and lower the opposite ends of the foothold; and a control section provided on the post for controlling the drive of the drive unit, wherein the drive unit comprises a drive source mounted on the base, rotational shafts connected to driving axes extending from the opposite sides of the drive source, eccentric discs each secured to one of the rotational shafts, eccentric axles each being formed one of the eccentric discs, and connecting rods each directly connected to one of the eccentric axles.

Here, each of the eccentric axles, to which connecting rods are connected, is formed on one of the eccentric discs at a position below the connection part between the eccentric disc and the rotational shaft, directly on the connection part between the eccentric disc and the rotational shaft, or at a position above the connection part between the eccentric disc and the rotational shaft.

The rotational diameter of the connecting rods respectively connected to the eccentric axles of the eccentric discs is in the range of 1 to 14 mm, and the rotational speed of the connecting rods is in the range of 1 to 60 cycles/sec.

The preferred embodiments will now be described below in detail in reference to the accompanying drawings.

### BRIEF DESCRIPTION OF THE DRAWINGS

The foregoing and other objects, features and advantages of the present invention will become more apparent from the following detailed description when taken in conjunction with the accompanying drawings, in which:

FIG. 1 is a perspective view, which shows a construction of a device for promoting decomposition of body fat and enhancing muscular strength in accordance with the first embodiment of the present invention;

FIG. 2 is an exploded perspective view, which shows a foothold and a drive unit of the device shown in FIG. 1;

FIG. 3a is a perspective view, which shows the position of the foothold before the connecting rods of the drive unit of FIG. 2 rotate;

FIG. 3b is a perspective view, which shows the position of the foothold after the connecting rods of the driving device of FIG. 2 have rotated;

FIG. 4a is a partial section view, which shows the position of a universal joint when the connecting rods each connected to one of the eccentric axles of rotational shafts in the drive unit shown in FIG. 2 have rotated downward;

FIG. 4b is a partial section view, which shows the position of the universal joint when the connecting rod connected to the eccentric axles of the rotational shafts in the drive unit shown in FIG. 2 has rotated upward;

FIG. 5 is an exploded perspective view, which shows a variant of a foothold connecting means in accordance with the first embodiment of the present invention;

FIG. 6a is a perspective view, which shows the position of the foothold before the connecting rods of the drive unit of FIG. 2 rotate, in which the drive unit employs the foothold connecting means of FIG. 5;

FIG. 6b is a perspective view, which shows the position of the foothold after the connecting rods of the drive unit of FIG. 2 have rotated, in which employs the foothold connecting means of FIG. 5;

FIG. 7 is an exploded perspective view, which shows the construction of a foothold and a drive unit in accordance with the second embodiment of the present invention;

FIG. 8a is a perspective view, which shows the position of the foothold before the connecting rods of the drive unit of FIG. 7 rotate;

FIG. 8b is a perspective view, which shows the position of the foothold after the connecting rods of the driving device of FIG. 7 have rotated;

FIG. 9 is an exploded perspective view, which shows a foothold and a drive unit in accordance with the third embodiment of the present invention;

FIG. 10a is a perspective view, which shows the position of the foothold before the connecting rods of the drive unit of FIG. 9 rotates;

FIG. 10b is a perspective view, which shows the position of the foothold after the connecting rods of the driving device of FIG. 9 have rotated;

FIG. 11 is an exploded perspective view, which shows a foothold and a drive unit in accordance with the fourth embodiment of the present invention;

FIG. 12a is a perspective view, which shows the position of the foothold before the connecting rods of the drive unit of FIG. 11 rotate;

FIG. 12b is a perspective view, which shows the position of the foothold after the connecting rods of the drive unit of FIG. 11 have rotated;

FIG. 13 is a front view, which shows the relative view of eccentric axles in relation to rotational shafts connected to eccentric discs in the drive unit of FIG. 11; and

FIG. 14 is a table, which shows the result of a clinical test, obtained using the device for promoting decomposition of body fat and enhancing muscular strength.

### BEST MODE FOR CARRYING OUT THE INVENTION

Hereinafter, the preferred embodiments of the present invention will be described in detail with reference to the drawings.

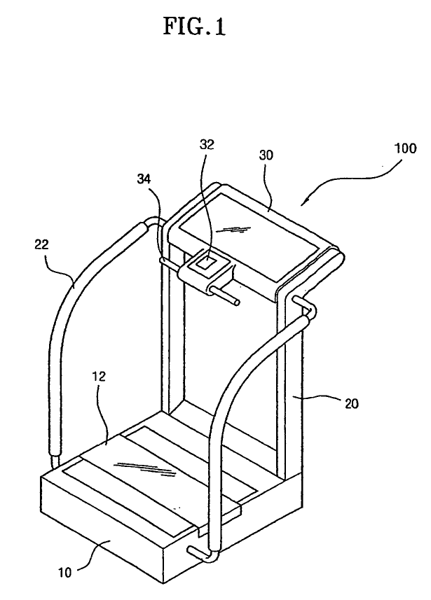

FIG. 1 is a perspective view, which shows a construction of a device for promoting decomposition of body fat and enhancing muscular strength in accordance with the first embodiment of the present invention.

The device for promoting decomposition of body fat and enhancing muscular strength 100 in accordance with the present invention comprises a base 10, a pair of posts 20 uprightly installed on one end of the base 10, and a control section 30 provide on the upper ends of the posts 20.

The base 10 is provided with a foothold 12 on which a user puts his (her) feet, wherein the foothold 12 is mounted to be movable up and down rather than being fixed. The foothold 12 is supported at its center part so that it is operated like a seesaw, not by user's muscular strength, but by separately provided power, thereby providing the user with exercising effect.

A first pair of handles 22 are provided on the opposite sides of the posts 20 uprightly installed on the one end of the base 10. The control section 30 is provided with a control panel 32 and a second pair of handles 34 are provided on the opposite sides of the free end of the control panel 32. The first and second handles 22 and 34 are provided for the safety of the user and a person having an ordinary skill in the art will appreciate that they can be formed in other shapes.

As described above, the control section 30 is formed on the upper ends of the posts 20, and a speed indicator, a calorie meter, a timer, a specific instrument for indicating exercise amount or the like may be arranged on the top portion of the control section 30. The control panel 32 allows the user to control speed, time, etc. The control panel 32 may control vibrational velocity in the range of 30 to 60 Hz in the high-speed vibration mode and in the range of 1 to 29 Hz in the low-speed vibration mode. The high-speed vibration mode is effective for enhancing muscular strength, treatment of osteoporosis, enhancing sense of balance, etc., and the low-speed mode is effective for posture reform, rehabilitation, treatment of herniated lumbar disc, treatment of obesity (burning of body fat), smoothing of blood circulation, facilitation of metabolism (relief of constipation), etc.

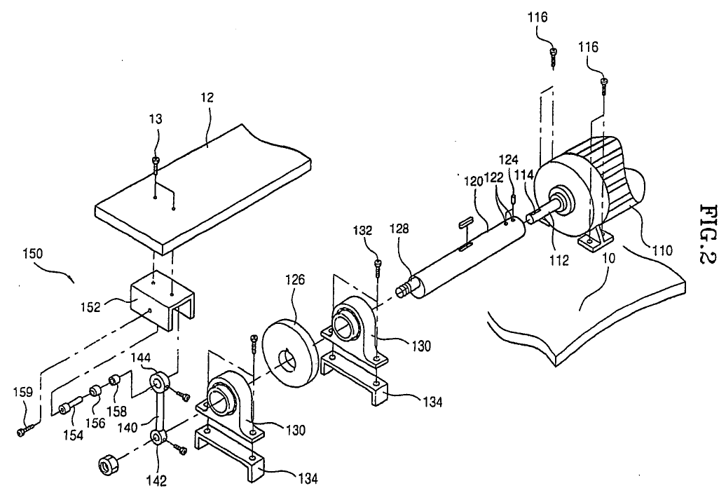

FIG. 2 is an exploded perspective view, which shows the foothold and a drive unit of the device shown in FIG. 1.

The power of the drive unit in accordance with the present invention is provided by a motor. 10, which is a drive source, as shown in FIG. 2. The drive of the motor 110 is controlled by a control signal inputted from the control section 30. It is preferable to use the motor 110 as the drive source, as shown in the drawing.

The motor 110 is secured on the base 10 by means of a plurality of bolts and a pair of motor spindles 112 are extended from the opposite ends of the motor 110. Each motor spindle 112 is connected with a rotational shaft 120, and an end of the rotational shaft 120 remote from the motor spindle 112 is provided with an eccentric axle 128, which is integral but eccentric to the motor spindle 112. Therefore, the power generated from the drive source is transmitted to each of the rotational shafts 120 via each of the motor spindles 120.

In addition, the rotational shaft 120 are firmly secured by keys 124 inserted into first key slots 114 formed on the free ends of the motor spindles 112 and second key slots 122 formed on one end of each rotational shaft 120.

Each of rotational shafts 120 is inserted through a pair of stationary bearings 130, which are in turn secured on brackets 134 fixed on the base 134 by means of bolts. 132. The brackets 134 function to minimize the assembling tolerance between the stationary bearings 130 and the rotational shaft 120.

A balance weight 126 is placed between the stationary bearings 130, and the rotational shaft 120 also extends through the balance weight 126.

Here, the balance weight 126 has a phase difference of 180° with reference to the eccentric axle 128 in order to compensate for the imbalance of force resulting from the rotation of the eccentric axle 128. The stationary bearings 130, through which the rotational shaft 120 is inserted, function to prevent the rotational shaft 120 from shaking. The eccentric axle 128 is inserted through a lower connection part 142 of the connecting rod 140. The eccentric axle 128 is provided on the rotational shaft 120 as described above, so that the connecting rod 140 performs eccentric rotation. The eccentric axle 128 is provided, so that the rotation diameter of the connecting rod 140 is in the range of 1 to 12 mm, preferably 6 to 7 mm.

A universal joint 150 is connected to the upper connection part 142 of the connecting rod 140. The universal joint 150 comprises: a bracket 152 secured to the foothold 12 by means of bolts 13; a connector 154 which has a head and an elongate cylindrical body of a small diameter; a universal bearing 156 positioned on the center of the connector 154, wherein the universal bearing 156 is connected with the upper connection part 144 of the connecting rod 140 and fitted around the cylindrical body of the connector 154; and a bush element 158 of a predetermined length, which is fitted around the cylindrical body of the connector 154 in order to prevent the universal bearing 156 from being moved along the cylindrical body. The connector 154 and the universal bearing 158 are positioned inside of the bracket 152 and secured by a bolt 159 which is inserted from the outside of the bracket 152.

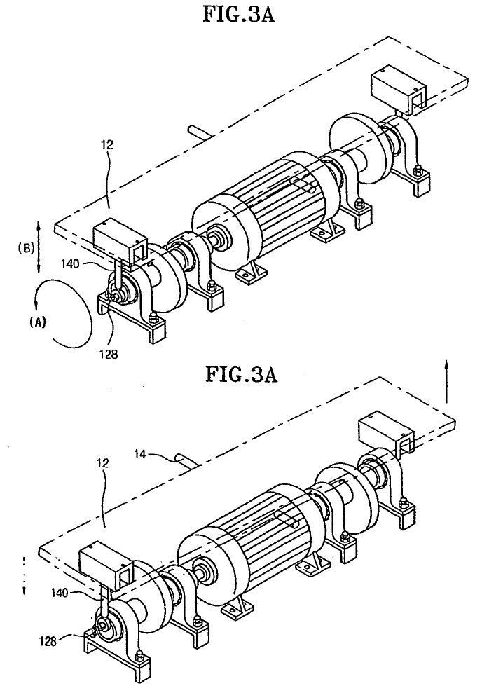

FIG. 3a is a perspective view, which shows the position of the foothold before the connecting rods rotate in the drive unit of FIG. 2.

As shown in FIG. 3a, each connecting rod 140 converts the eccentric rotation movements (A) of each eccentric axle 128 into vertical movements (B) so that opposite sides of the foothold 12 rise and fall like a seesaw. The opposite eccentric axles 128 are arranged to have a phase difference of a predetermined obtuse angle, preferably 180° between them, so that if one of the eccentric axles 128 rises, the other falls.

FIG. 3b is a perspective view, which shows the position of foothold after the connecting rods have rotated in the drive unit of FIG. 2.

As shown in FIG. 3b, if the rotational shafts 120 rotate 180°, the connecting rods 140 connected to the eccentric axles 128 convert rotation movements into vertical movements while rotating, so that the foothold 12 connected to the connecting rods 140 performs seesaw movements.

If one of the connecting rods 140 rises, the other falls because the eccentric axles 128 are arranged to have a phase difference of 180°. As a result, the both sides of the foothold 12 periodically repeat up and down movements centering around a support rod 14. Preferably, the lowest rotation velocity of the connecting rods 130 is in the range of 1 to 60 rounds per second.

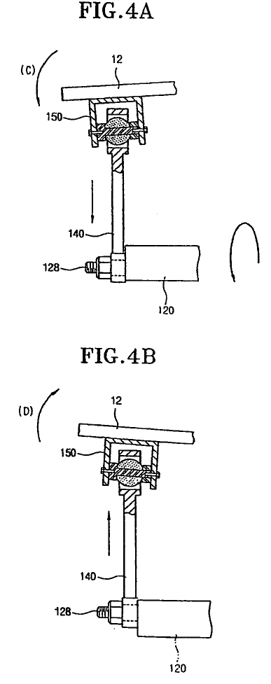

FIG. 4a is a partial section view, which shows the position of the universal joint when the connecting rod connected to the eccentric axle in the drive unit is rotated downward.

As shown in FIG. 4a, when the eccentric axle 120 is in the lowermost position, the left side of the foothold 12 connected to the connecting rod 140 is tilted in the direction C and maintained in its lowered position. In this situation, because the universal joint 150 is secured to the connecting rod 140, the load produced from the tilting of the foothold 12 can be minimized.

FIG. 4b is a partial section view, which shows the position of the universal joint when the connecting rod connected to the eccentric axle in the drive unit is rotated upward.

As shown in FIG. 4b, when the eccentric axle 120 is in the uppermost position, the left side of the foothold 12 connected to the connecting rod 140 is tilted in the direction D and maintained its raised position. Likewise in this situation, because the universal joint 150 is secured to the connecting rod 140, the load produced from the tilting of the foothold 12 can be minimized, with the result that seesaw movement is performed.

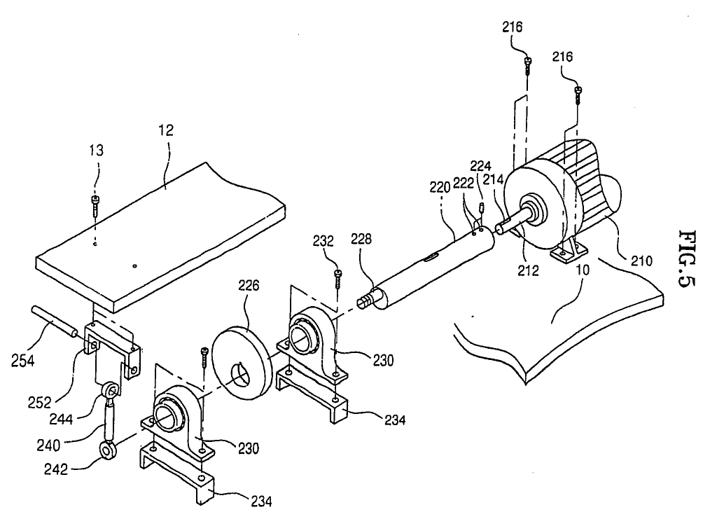

FIG. 5 is an exploded perspective view, which shows a variant to the foothold connecting means in accordance with the first embodiment of the present invention.

The power generated from the driving source is transmitted to the rotational shafts 220 which are respectively connected to the motor spindles 212 extended from the opposite sides of the motor 210. The motor 210 is secured to the base 10 by means of the bolts 216. The rotational shafts 220 are secured by inserting keys 224 into the first key slots 214 formed in the frond ends of the motor spindles 212 and the second key slots 222 formed in the rear ends of the rotational shafts 220.

Each of the rotational shafts 220 is fitted through the stationary bearings 230 and the stationary bearings 230 are secured on the brackets 234 by means of the bolts fixed on the base 10. The brackets 234 function to minimize the assembling tolerance between the stationary bearings and the rotational shaft 220.

The rotational shaft 220 extends through a balance weight 226. The balance weight is arranged to have a phase difference of 180° with reference to the eccentric axle 228 in order to compensate for the tension exerted by the eccentric axle 128. The stationary bearings 130 function to prevent the rotational shaft 220 from shaking while rotating. The rotational shaft 220 is connected to the lower connection part 242 of the connecting rod 240. The eccentric axle 228 is provided on the rotational shaft 220, so that the connecting rod 240 performs eccentric rotation. The eccentric axle 228 is provided, so that the rotation diameter of the connecting rod 240 is in the range of 1 to 12 mm, preferably 6 to 7 mm.

The upper connection part 244 of the connecting rod 240 is rotatably connected to a bracket 252 through a connector 254, in which the bracket 252 is secured to the foothold 12 by means of the bolts 14.

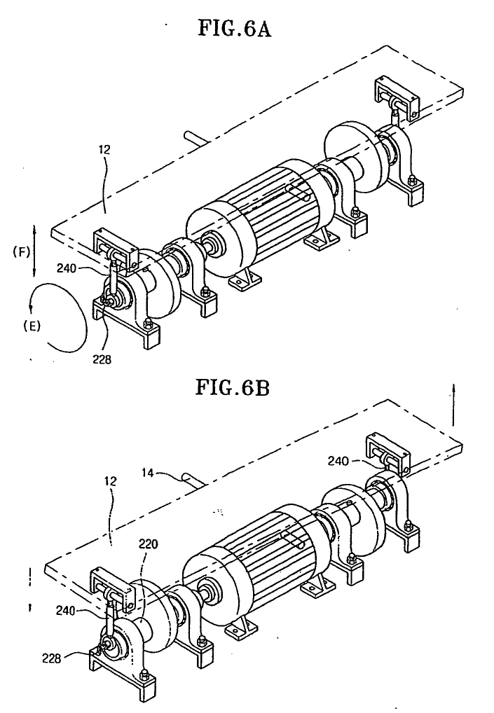

FIG. 6a is a perspective view, which shows the position of the foothold before the connecting rods are rotated in the drive unit of FIG. 2, in which the drive unit employs the foothold connecting means of FIG. 5.

AS shown in FIG. 6a, the connecting rods 240 convert the rotation movements (E) of the eccentric axles 228 into vertical movements (F), so that the opposite sides of the foothold 12 rise and fall, thereby performing seesaw movements. The opposite eccentric axles 228 are arranged to have a phase difference of a predetermined obtuse angle, preferably 180° therebetween, so that if one of the eccentric axles 228 rises, the other falls.

FIG. 6b is a perspective view, which shows the position of foothold after the connecting rods have rotated in the drive unit of FIG. 2, in which the drive unit employs the foothold connecting means of FIG. 5.

As shown in FIG. 6b, if the rotational shafts 220 rotate about 180°, the connecting rods 240 connected to the eccentric axles 228 convert rotation movements into vertical movements while rotating, so that the foothold 12 connected to the connecting rods 240 performs seesaw movements.

If one of the connecting rods 240 rises, the other falls because the eccentric axles 228 are arranged to have a phase difference of 180°. As a result, the both sides of the foothold 12 periodically repeat up and down movements centering around a support rod 14. Preferably, the lowest rotation velocity of the connecting rods 240 is in the range of 1 to 60 rounds per second.

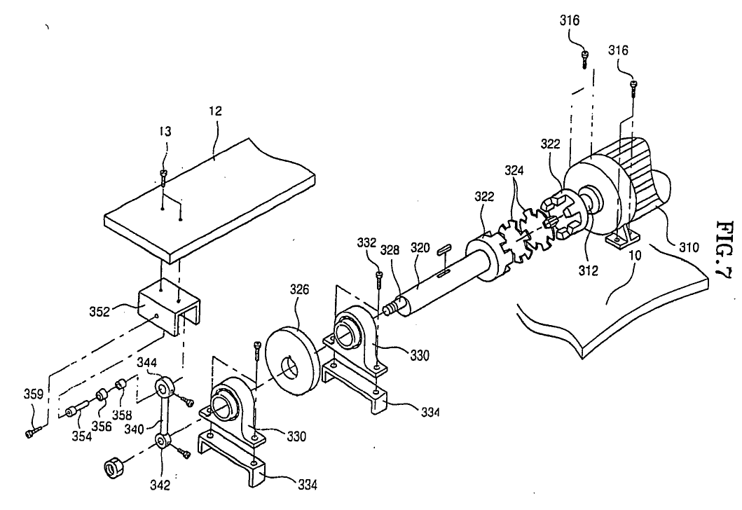

FIG. 7 is an exploded perspective view, which shows the construction of the foothold and the drive unit in accordance with the second embodiment of the present invention.

The power generated from the driving source is transmitted to the rotational shafts 314 which are respectively connected to the motor spindles 312 extended from the opposite sides of the motor 310. The motor 310 is secured to the base 10 by means of the bolts 316.

The rotational shafts 320 comprise a toothed coupling 324. The toothed couplings 324 are gears with axially extended teeth and urethane joints 324 are inserted in the spaces formed between adjacent teeth in order to reduce the noise and friction. Furthermore, each of the rotational shafts 320, onto which a toothed coupling 324 is provided, is inserted through the stationary bearings 330, and the stationary bearings 330 are secured on the brackets 334 fixed on the base 10. The brackets 334 minimize the assembling tolerance between the stationary bearings 330 and the rotational shaft 320.

The rotational shaft 320 extends through a balance weight 326. The balance weight is arranged to have a phase difference of 180° with reference to the eccentric axle 328 in order to compensate the tension exerted by the eccentric shaft 328. The stationary bearings 330 function to prevent the rotational shaft 320 inserted through the stationary bearings 330 from shaking while rotating. The rotational shaft 320 is connected to the lower connection part 342 of the connecting rod 340. The eccentric axle 328 is provided on the rotational shaft 320, so that the connecting rod 340 performs eccentric rotation. The eccentric axle 328 is provided, so that the rotation diameter of the connecting rod 340 is in the range of 1 to 12 mm, preferably 6 to 7 mm.

A universal joint 350 is connected to the upper connection part 344 of the connecting rod 340. The universal joint 350 comprises: a bracket 352 secured to the foothold 12 by means of bolts 13; a connector 354 which has a head and an elongated cylindrical body of a small diameter; a universal bearing 356 positioned on the center of the connector 354, wherein the universal bearing 356 is connected with the upper connection part 344 of the connecting rod 340 and fitted around the cylindrical body of the connector 354; and a bush element 358 of a predetermined length, which is fitted around the cylindrical body of the connector 354 in order to prevent the universal bearing 356 from being moved along the cylindrical body. The connector 354 and the universal bearing 358 are positioned inside of the bracket 352 and secured by a bolt 359 which is inserted from the outside of the bracket 352.

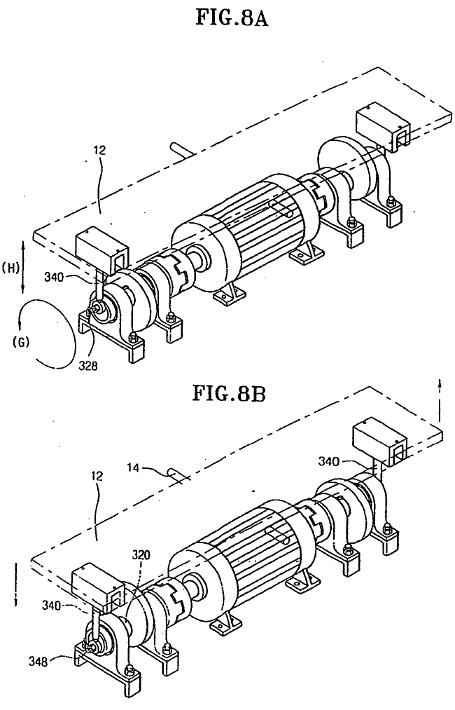

FIG. 8a is a perspective view, which shows the position of the foothold before the connecting rods rotate in the drive unit of FIG. 7.

As shown in FIG. 8a, the connecting rods 340 convert the rotation movements (G) of the eccentric axles 228 into vertical movements (H), so that the opposite sides of the foothold 12 rise and fall, thereby performing seesaw movements. The opposite eccentric axles 328 are arranged to have a phase difference of a predetermined obtuse angle, preferably 180° between them, so that if one of the eccentric axles 328 rises, the other falls.

FIG. 8b is a perspective view, which shows the position of the foothold after the connecting rods have rotated in the drive unit of FIG. 7.

As shown in FIG. 8b, if the rotational shafts 320 rotate about 180°, the connecting rods 340 connected to the eccentric axles 328 convert rotation movements into vertical movements while rotating, so that the foothold 12 connected to the connecting rods 340 performs seesaw movements.

If one of the connecting rods 340 rises, the other falls because the eccentric axles 328 are arranged to have a phase difference of 180°. As a result, the both sides of the foothold 12 periodically repeat up and down movements centering around a support rod 14. Preferably, the lowest rotation velocity of the connecting rods 340 is in the range of 1 to 60 rounds per second.

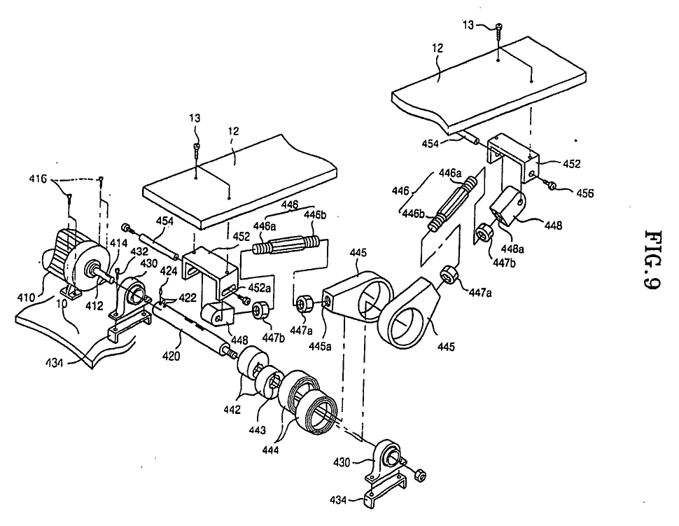

FIG. 9 is an exploded perspective view, which shows the construction of the foothold and the drive unit in accordance with the third embodiment of the present invention.

The drive unit in accordance with this embodiment of the present invention comprises: a motor 410, a rotational shaft 420, a pair of stationary bearings 430, a pair of eccentric cams 442, a pair of bearings 444, a pair of housing members 445, a pair of length-controlled tie rods 446, a pair of foothold connection pieces 448, and a pair of brackets 452.

The motor 410 is secured to the base 10 by means of bolts 416 and serves as a driving source for generating power. The motor 410 is provided with a motor spindle 412 and the motor spindle 412 projects outwardly through a side of the motor 410. The free end of the motor spindle 412 is formed with one or more first key slots 414 and one end of the rotational shaft 420 is formed with one or more second key slots 422. Keys 424 are press-fitted through the first and second key slots 414 and 422, so that the rotational shaft 420 and the motor spindle 412 are connected with each other and thus integrally rotate. Therefore, the power generated from the motor 410 is transmitted to the rotational shaft 420 through the motor spindle 412.

The rotational shaft 420 is fitted through a pair of stationary bearings 430, and the stationary bearings 430 are secured on the brackets 434 by means of bolts 432. The brackets are fixed on the base 10. The brackets 434 fiction to minimize the assembling tolerance between the stationary bearings 430 and the rotational shaft 420. A pair of eccentric cams 442 are arranged between the stationary bearings 430 and the rotational shaft 420 is inserted through the eccentric cams 442 and fixed by keys (not shown).

Each of the eccentric cams 442 is formed with an eccentric hole 443. The eccentric holes 443 are arranged to have a phase difference of 180° when the rotational shaft 420 is fixed with respect to the eccentric cams 442. The eccentric cams 442 are fitted into the bearings 444, respectively and the bearings 444 are press-fitted into the housing members 445, respectively.

One end of each housing member 445 is formed with a screw hole 445. Each of the length controlled tie rods 446 is formed with external screw threads 446a and 446b on the opposite ends thereof. The external screw threads 446b formed on one end of each tie rod 446 is thread-fitted with the screw hole 445a provided in each housing member 445. Here, the external screw threads 446b are thread-fitted with the screw hole 445a in the state that a lock nut 447a is thread-fitted onto the external screw threads 446b. The lock nut 447a limits the length of the length-controlled tie rod 446 to be inserted into the screw hole 445a, thereby controlling the effective length of the tie rod 446.

Each of the foothold connection pieces 448 is formed with a screw holes 448a, and the external screw threads formed on the other end of each length-controlled tie rod 446 are thread-fitted with the screw hole 448a. Here, the external screw threads 446a are thread-fitted with the screw hole 445a in the state that a lock nut 447b is thread-fitted onto the external screw threads 446a. The lock nut 447b limits the length of the length-controlled tie rod 446 able to be inserted into the screw hole 448a, thereby also controlling the effective length of the tie rod 446.

Each of the brackets 452 has sidewalls, each of which is formed with an anchoring opening 452a. Opposite ends of a hinge pin 454 are inserted into the anchoring openings 452a formed in each bracket 452. Each hinge pin 454 is inserted through a guide hole formed on each connection piece 448 and then the opposite ends are inserted to the anchoring openings 452a, respectively. Thereafter, a pair of bolts 456 are fitted into the opposite ends of each hinge pin 454 from the outside of the sidewalls of each bracket 452, as a result of which the length-controlled tie rod 446 is rotatably supported by the hinge pin 454. Each bracket 452 is secured to the foothold 12 by the bolts 13. In order to assure reliable seesaw movements of the foothold 12 of the drive unit in accordance with the present invention, the anchoring openings 452a, which are formed in one of the brackets 452, are elongate holes, i.e. slots. Therefore, it will be appreciated that when the foothold 12 is moved like a seesaw, one of the length-controlled tie rods 446 is movable in the widthwise direction of the bracket along the slots

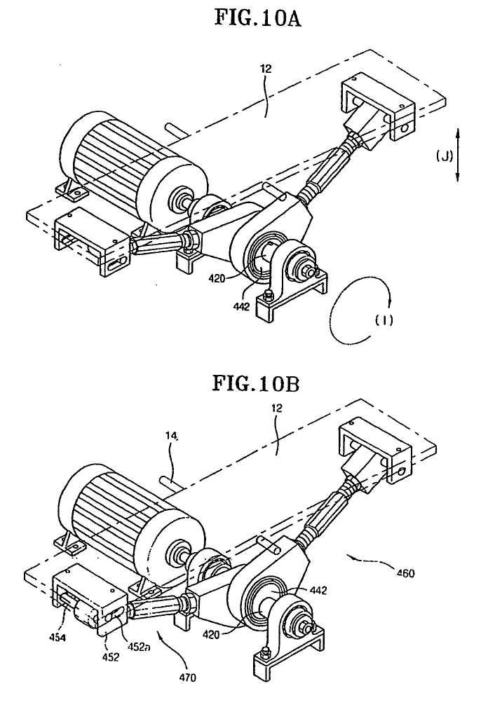

FIG. 10a is a perspective view, which shows the position of the foothold before the rotational shaft is rotated in the drive unit of FIG. 9.

As shown in FIG. 10a, the rotational movements (I) of the eccentric cams 442 fitted onto the rotational shaft 420 are converted into rectilinear movements (J), so that opposite sides of the foothold 12 rise and fall, thereby causing the foothold 12 to perform seesaw movements. The eccentric axles 443 are arranged to have a phase difference of a predetermined obtuse angle, preferably 180°, so that if one of the eccentric cams 442 rises, the other falls.

FIG. 10b is a perspective view, which shows the position of the foothold after the rotational shaft has been rotated in the drive unit of FIG. 9.

As shown in FIG. 10b, if the rotational shaft 420 of FIG. 10a rotates about 180°, there is a difference in length between the rotating diameters of the center points of the eccentric cam and of the eccentric axle 443. Due to this difference of the rotating diameters, if the eccentric cams 442 rotate, the rotational movements of the eccentric cams 442 are converted into rectilinear movements and thus the foothold performs seesaw movements. In this case, the securing openings 452a formed in one of the left and right brackets 452 extend by a predetermined length, so that the hinge pin 456 is movable in the widthwise direction of the bracket 452. This is because unless one of the hinge pins 456 is movable, the eccentric cams cannot rotate as the two hinge pins 456 have a phase difference of 180° with each other.

Due to the fact that the eccentric axles 443 have a phase difference of 180°, if one power transmission section 460 rises, the other power transmission section 470 falls. Therefore, the opposite sides repeat up and down movements centering around the support rod 14. In this case, it is preferred that the lowest velocity of the power transmission sections 460, 470 is in the range of 1 to 60 rounds per second.

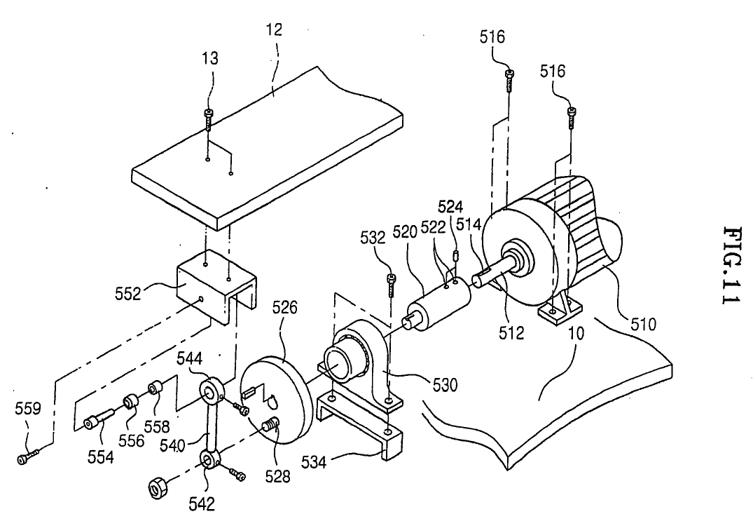

FIG. 11 is an exploded perspective view, which shows the construction of the foothold and the drive unit in accordance with the fourth embodiment of the present invention.

The power generated from the driving source is transmitted to each of rotational shafts 520 which are connected to motor spindles 512, in which each spindle extends from opposite sides of a motor 510 fixed on a base 10 by means of bolts 516.

Each rotational shaft 520 is secured to one of the motor axles 412 by fitting keys 524 into first key slots 514 formed in the free end of the motor axle 412 and second key slots 522 formed in the rear end of the rotational shaft 520.

Each rotational shaft 520 is inserted through one of a pair of stationary bearings 530 and the stationary bearings 530 are secured to brackets 534 by means of bolts 532, in which the brackets 534 are secured to the base 10. The brackets 534 function to minimize the assembling tolerance between the stationary bearings 530 and the rotational shafts 520.

Each rotational shaft 520 is connected to an eccentric disc 526, in which the eccentric disc 526 is provided with an eccentric axle 528, which extends along the direction of the rotational shaft 520.

A lower connection part 542 of a connecting rod 540 is rotatably connected to the eccentric axle 528 provided in the eccentric disc 526. In this case, the rotating diameter of the connecting rod is in the range of about 1 to 11 mm, preferably 6 to 7 mm.

A universal joint 550 is connected to an upper connection part 544 of the connecting rod 540. The universal joint 550 comprises: a bracket 552 secured to the foothold 12 by means of bolts 13; a connector 554 which has a head and an elongate cylindrical body of a small diameter; a universal bearing 556 positioned on the center of the connector 554, wherein the universal bearing 556 is connected with the upper connection part 544 of the connecting rod 540 and fitted around the cylindrical body of the connector 554; and a bush element 158 of a predetermined length, which is fitted around the cylindrical body of the connector 554 in order to prevent the universal bearing 556 from being moved along the connector 554. The connector 554 and the universal bearing 558 are positioned inside of the bracket 552 and secured by a bolt 559 which is inserted from the outside of the bracket 552.

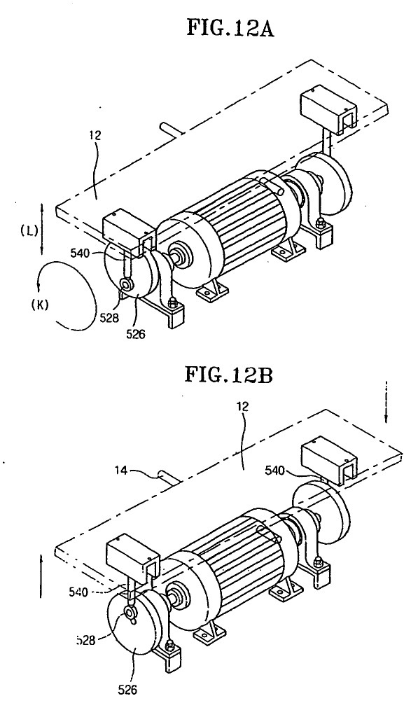

FIG. 12a is a perspective view, which shows the position of the foothold before the connecting rods rotate in the drive unit of FIG. 11.

As shown in FIG. 12a, each connecting rod 540 converts the eccentric rotation movements (K) of each eccentric axle 528 into vertical movements (L) so that opposite sides of the foothold 12 rise and fall, thereby affording seesaw movements to the foothold 12. The opposite eccentric axles 528 are arranged to have a phase difference of a predetermined obtuse angle, preferably 180° between them, so that if one of the eccentric axles 528 rises, the other falls.

FIG. 12b is a perspective view, which shows the position of foothold after the connecting rods have rotated in the drive unit of FIG. 11.

As shown in FIG. 12b, if the eccentric discs 526 rotate 180°, the connecting rods 540 connected to the eccentric axles 528 convert rotation movements into vertical movements while rotating, so that the foothold 12 connected to the connecting rods 540 performs seesaw movements.

Due to the fact that the eccentric axles 528 are arranged to have a phase difference of 180°, if one of the connecting rods 540 rises, the other falls. As a result, the both sides of the foothold 12 periodically repeat up and down movements centering around a support rod 14. Preferably, the lowest rotation velocity of the connecting rods 540 is in the range of 1 to 60 rounds per second.

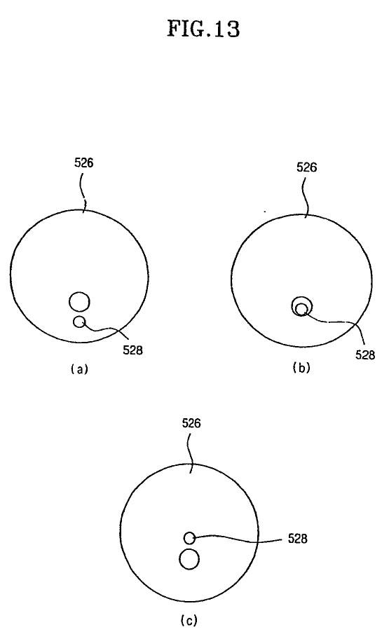

FIGS. 13a to 13c are front views, which show various relative positions of an eccentric axle in relation to a rotational shaft connected to an eccentric disc.

In FIG. 13a, the eccentric axle 528 is provided below the joint part between the rotational shaft 520 and the eccentric disc 526. In FIG. 13b, the eccentric axle 528 is directly provided at the joint part between the eccentric disc 526 and the rotational shaft 520. In FIG. 13c, the eccentric disc 528 is provided above the joint part between the rotational shaft 520 and the eccentric disc 526, i.e., at the center of the eccentric disc 526.

Therefore, in the case of FIGS. 13a and 13b, the power generated from the motor 510 may exert one-directional forces for movements, while in the case of FIG. 13c, the power generated from the motor 510 may exert respective forces for movements.

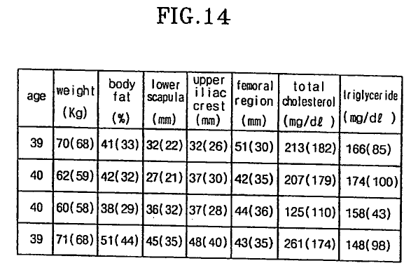

FIG. 14 is a table, which shows the results of clinical trials obtained by using a device for promoting decomposition of body fat and enhancing muscular strength in accordance with the present invention.

Clinical trials were performed for six weeks (five days/week) and mean caloric intake per one day of each subject was 2045 cal, which is similar to that of a normal human. Exercise was performed for five minutes in a horseback riding posture and for two minutes in a standing posture. Here, the numerical values within parentheses indicate the results after clinical trials.

As indicated in FIG. 14, it can be confirmed that general body indexes were reduced, although there are some differences depending on ages. In particular, thirty steps are required to consume 1 kcal in walking exercise. This is calculated in terms of time considering working speed: one usual step reaches to about 65 cm and thus one hundred steps reach to 65 m. In usual, human's walking speed is about 3.9 km/h. Therefore, in order to consume 300 kcal, it is required to walk for 90 minute.

### INDUSTRIAL APPLICABILITY

As discussed above, the device for promoting decomposition of body fat and enhancing muscular strength in accordance with the present invention allows exercise to be taken using its own drive unit without relying on user's muscular strength, as a result of which not only a normal human but also a physically handicapped person can easily treat obesity.

In addition, it is possible to control the vibrational (up and down movement) velocity of the foothold The high-speed vibration mode is effective for enhancing muscular strength, treatment of osteoporosis, enhancing sense of balance, etc. and the low-speed vibration mode is effective for posture reform, rehabilitation, treatment of herniated lumbar disc, treatment of obesity (burning of body fat), smoothing of blood circulation, facilitation of metabolism (relief of constipation), etc. Furthermore, no strain is put on the user by taking exercise and the exercise is not restricted by age, height, weight, etc., of the user.

Because the device for promoting decomposition of body fat and enhancing muscular strength in accordance with the present invention allows body fat to be burnt and thus muscular strength to be enhanced through passive exercise, it is possible to control a “yo-yo” phenomenon.

The preferred embodiment of the present invention has been described for illustrative purposes, and those skilled in the art will appreciate that various modifications, additions and substitutions are possible, without departing from the scope and spirit of the invention as disclosed in the accompanying claims.

1. A device for promoting decomposition of body fat and enhancing muscular strength, comprising:
a base seated on a horizontal surface;
a post uprightly provided in the front part of the base; a foothold mounted to be vertically movable on the base, on which a user rests his feet;
a drive unit provided in the base in order to periodically and alternately raise and lower the opposite ends of the foothold; and
a control section provided on the post for controlling the drive of the drive unit,
wherein the drive unit comprises a drive source mounted on the base, rotational shafts, which are respectively connected to driving axes extending from the opposite sides of the drive source, balance weights each being secured to one of the rotational shafts, which extend through the balance weights, eccentric axles each being directly formed on one of the rotational shafts, and connecting rods each being connected to one of the eccentric axles.

2. The device according to claim 1, wherein the foothold is abutted at the center part between the left and right ends thereof, and the connecting rods are connected to fastening means secured to each end of the foothold, so that the connecting rods afford periodic seesaw movements to the foothold.

3. The device according to claim 1, wherein the eccentric axles formed on the rotational shafts and connected to the connecting rods have a phase difference of 180° between them, so that if one of the eccentric axles is positioned at the uppermost position, the other is positioned at the lowermost position while the rotational shafts are rotating.

4. The device according to claim 1, wherein the rotational diameter of the connecting rods connected to the eccentric axles of the rotational shafts is in the range of 1 to 14 mm, and the rotational speed of the connecting rods is in the range of 1 to 60 cycles/sec.

5. The device according to claim 1, wherein the control panel controls the vibrational speed in the range of 30 to 60 Hz at high-speed vibrational exercise mode, and controls the vibrational speed in the range of 1 to 29 Hz at low-speed vibrational excise mode.

6. A device for promoting decomposition of body fat and enhancing muscular strength, comprising:
a base seated on a horizontal surface;
a post uprightly provided in the front part of the base;
a foothold mounted to be vertically movable on the base, on which a user rests his feet;
a drive unit provided in the base in order to periodically and alternately raise and lower the opposite ends of the foothold; and
a control section provided on the post for controlling the drive of the drive unit,
wherein the drive unit comprises a drive source mounted on the base, couplings connected to driving axes extending from the opposite sides of the drive source, joint members residing between the couplings in order to reduce noise and friction, rotational shafts connected to the joint members, balance weights each secured to one of the rotational shafts which extend through the balance weights, eccentric axles each being directly formed on one of the rotational shafts, and connecting rods each being directly connected to one of the eccentric axles.

7. The device according to claim 6, wherein each coupling is formed from two toothed gears, which are mated with each other thereby transferring rotational movements.

8. The device for promoting decomposition of body fat and enhancing muscular strength comprising:
a base seated on a horizontal surface;
a post uprightly provided in the front part of the base;
a foothold mounted to be vertically movable on the base, on which a user rests his feet;
a drive unit provided in the base in order to periodically and alternately raise and lower the opposite ends of the foothold; and
a control section provided on the post for controlling the drive of the drive unit,
wherein the drive unit comprises a drive source mounted on the base, rotational shafts connected to driving axes extending from the opposite sides of the drive source, eccentric cams each eccentrically secured to one of the rotational shafts, bearings each fitted around one of the eccentric cams, housings each fitted to enclose one of the eccentric cams, foothold connection parts connected to the foothold, length-controlled tie rods each extending between one of the housings and one of the foothold connection parts and screwed to the housing and the foothold connection part at its opposite ends, and anchoring nuts for securing the adjusted lengths of the tie rods connected to the housings and foothold connection parts.

9. The device according to claim 8, wherein the foothold is abutted at the center part between the left and right ends thereof, and the connecting rods are connected to fastening means secured to each end of the foothold, so that the connecting rods afford periodic seesaw movements to the foothold.

10. The device according to claim 9, wherein the fastening means comprises connecting means and left and right brackets.

11. The device according to claim 9, wherein one of the left and right brackets provided with securing holes extending in a predetermined length so that the connecting means is movable in the widthwise direction of the bracket.

12. The device for promoting decomposition of body fat and enhancing muscular strength, comprising:
a base seated on a horizontal surface;
a post uprightly provided in the front part of the base;
a foothold mounted to be vertically movable on the base, on which a user rests his feet;
a drive unit provided in the base in order to periodically and alternately raise and lower the opposite ends of the foothold; and
a control section provided on the post for controlling the drive of the drive unit,
wherein the drive unit comprises a drive source mounted on the base, rotational shafts connected to driving axes extending from the opposite sides of the drive source, eccentric discs each secured to one of the rotational shafts, eccentric axles each being formed one of the eccentric discs, and connecting rods each directly connected to one of the eccentric axles.

13. The device according to claim 12, wherein each of the eccentric axles, to which connecting rods are connected, is formed on one of the eccentric discs at a position below the connection part between the eccentric disc and the rotational shaft, directly on the connection part between the eccentric disc and the rotational shaft, or at a position above the connection part between the eccentric disc and the rotational shaft.

14. The device according to claim 12, wherein the rotational diameter of the connecting rods respectively connected to the eccentric axles of the eccentric discs is in the range of 1 to 14 mm, and the rotational speed of the connecting rods is in the range of 1 to 60 cycles/sec.
